(19) United States
(12) Patent Application Publication
(10) Pub. No.: US 2003/0008605 A1
(43) Pub. Date: Jan. 9, 2003

(54) Livestock processing facility

(76) Inventors: Gerald D. Hartford JR., Fargo, ND (US); Robert G. Breukelman, Sioux Falls, ND (US)

Correspondence Address: KINNEY & LANGE, P.A., THE KINNEY & LANGE BUILDING, 312 SOUTH THIRD STREET, MINNEAPOLIS, MN, 55415-1002, US

(21) Appl. No.: 10/178,077

(22) Filed: Jun. 20, 2002

Related U.S. Application Data
(60) Provisional application No. 60/299,544, filed on Jun. 20, 2001.

(51) Int. Cl. A22B 3/00

(52) U.S. Cl. 452/52; 452/198

(57) ABSTRACT

A livestock processing facility comprising a waste area, a processing area, a storage area and a packaging area. The processing area comprises at least two processing portions wherein each processing portion is positioned such that the processing area at least partially circumscribes the waste area. Waste from any processing portion of the processing area is directly fed through conduits without passing through any other area of the facility. A processing portion of the processing area includes a self-cleaning system to wash and sanitize the processing portion at regular intervals. The storage area includes separate modular coolers wherein the temperature of each cooler can be controlled independent of any other. Each area of the processing facility is positioned and designed to control the flow of air away from the storage and packaging areas toward the waste area.

### CROSS-REFERENCE TO RELATED APPLICATION(S)

Applicant claims the priority date of U.S. Provisional Application No. 60/299,544 filed on Jun. 20, 2001.

### BACKGROUND OF THE INVENTION

The present invention relates to a livestock processing facility. In particular, the present invention relates to the regulation of air flow and the sanitization of a livestock processing facility.

An essential element in the production of meat products is the processing of livestock at a processing facility, commonly known as a slaughterhouse or an abattoir. At such facilities, livestock such as cattle, pigs, chickens and the like, which were raised on either grazing facilities or feedlots, are brought to be slaughtered. The basic steps in slaughter include stunning, bleeding, hide removal, evisceration and carcass dressing. Deboning of the carcasses may also occur at the slaughterhouse, or may occur at other processing facilities.

During the slaughtering process, especially during bleeding, evisceration and carcass dressing, (which is known to those skilled in that art as carcass work-up) there is a great need for the containment and disposal of fluids and other biological matter that results from the slaughter. If not properly contained, these fluids and biological matter can contaminate the carcasses, which in turn either spoils or discolors the meat, brings about an unpleasant odor, or infects the meat with pathogens which can lead to malaise or the spread of disease upon consumption of the meat. It is therefore essential that these fluids and biological matter be contained away from fully processed carcasses. It is also essential that the migration of pathogens from the processing areas be prevented from entering into storage areas of the processing facility. Conventional processing facilities currently employ a variety of methods for the removal of waste and the containment of pathogens to certain areas. These methods, however, are inefficient in that the layout of conventional processing facilities makes it difficult, if not impossible, to keep waste and airborne pathogens away from carcasses passing throughout the facility. Many conventional processing facilities comprise a single open-air area wherein all steps of the slaughtering process occur with no barriers preventing air from traveling from one portion of the facility to the other. Such facilities may include fans blowing air from one side of the building to the other, however, this alone does not provide consistent differential pressures between individual sections or portions of the facility. These same facilities will typically have a waste area set aside in a corner of the facility, wherein waste from distant portions of the facility has to travel through other portions to be deposited in the waste area.

Other facilities have been designed in a vertical fashion, comprising multi-floor units wherein a certain step of the slaughtering process occurs on each floor. These types of facilities have also shown to be difficult in controlling air flow from one floor to the next. There are typically waste areas set aside on each floor, continuously putting waste in close proximity to the processed carcass.

Additionally, another problem the conventional facilities encounter is the sanitation and maintenance of the cooling systems. It is quite critical that the carcasses be chilled as quickly as possible to reduce the spoilage of the meat, and to reduce the time in which airborne pathogens are viable. Conventional processing plants typically have a single storage area or cooler in which to store the carcasses after processing.

During a shift, many warm carcasses are brought into the cooler to be chilled. Continually supplying warm carcasses in the presence of chilled carcasses tends to increase the temperature of the chilled carcasses, which can lead to a greater chance of spoilage. Also, when continually bringing carcasses into the cooler, it is difficult to prevent the entrance of warm air into the cooler, further increasing the difficulty of maintaining a steady temperature within the cooler. Maintenance and cleaning are also problems because the entire cooling system needs to be shut down in order to conduct the maintenance or the cleaning of the cooler. Additionally, if the cooling system itself malfunctions, the cooler will not provide adequate cooling of the carcasses within, typically resulting in a loss of the carcasses. When cleaning or maintenance is performed on the cooler, the entire processing facility must usually come to a halt before any additional carcasses can be processed.

Additionally, sanitation of the processing areas is essential in the prevention of pathogen migration. This is especially true in a carcass work-up area, wherein skinned carcasses expose meat to the open air. The exposed meat can become contaminated due to contact with fecal matter or other evisceration debris continually present under such conditions. Current sanitation methods are also inefficient in that a considerable amount of “down time” takes place in order to maintain the strict sanitization requirements. In order to maximize production, the intervals between cleansing are maximized or lengthened to a point where the likelihood of contamination at the end of the interval is substantially greater than the likelihood of contamination at the beginning of the interval.

This is also true for temporary storage facilities, or cooling systems, within the conventional processing facilities. It is quite typical that in order to thoroughly clean the refrigeration portion of the storage facility, the entire refrigeration portion must be shut down and temperatures within allowed to rise to ambient temperature in order to adequately clean the refrigerated area. Once again, in order to maximize output, the intervals between cleaning are maximized or lengthened to a point where the likelihood of contamination at the end of the interval is substantially greater than the likelihood of contamination at the beginning of the interval.

Conventional processing facilities typically perform “washdowns” between shifts or at the end of the day. A shift can typically last for 8 hours or more. However, it has been shown that bacteria and other pathogens within such facilities increase at an exponential rate, vastly increasing the chance that the carcasses may be infected with such pathogens after about four hours.

The layout of conventional processing facilities also affects the time between euthanization and disemboweling the animal, also known to those skilled in the art as the “stick-to-gut” time. Minimizing the “stick-to-gut” time is advantageous for several reasons, including improving taste qualities of the meat. Minimizing the “stick-to-gut” time reduces time to cool the carcass, to better hinder biological breakdown of the meat by maintaining certain pH levels within in the meat. Conventional processing facilities typically have a “stick-to-gut” time of about 16-20 minutes for scalding operation used in conjunction with hogs, and about 15 minutes for a cattle operation.

### BRIEF SUMMARY OF THE INVENTION

A livestock processing facility is designed to reduce the migration of pathogens within selected areas of the processing facility. The processing facility comprises a processing area, a waste receiving area, a storage area and a packaging area. Preferably, the waste area is central to the processing area wherein the processing area at least partially circumscribes the waste receiving area in a substantially “L”-shaped configuration. Both the processing area and the waste receiving area are separated from the storage area to minimize the migration of pathogens. The waste area acts as a barrier between a “dirty side” of the processing facility where animals are brought in and slaughtered, and a “clean side” of the processing facility where edible meat products are cooled and prepared for packaging. The layout of the facility also facilitates control of differential air pressures between each area. The processing area includes an automatic cleaning system to thoroughly remove evisceration debris at regular intervals. The storage area includes modular coolers whose temperatures can be controlled independent of one another.

### BRIEF DESCRIPTION OF THE DRAWINGS

FIG. 1 is a perspective view of a processing facility of the present invention.

FIG. 2 is a plan view of the processing facility of the present invention.

FIG. 3 is a perspective view of an outward structure of a slaughter chamber of the processing area of the present invention.

FIG. 4 is a perspective view of the slaughter chamber of the of the processing area of the present invention during the processing of carcasses.

FIG. 5 is a perspective view of the slaughter chamber of the processing area of the present invention during a washing cycle.

FIG. 6 is a perspective view of the slaughter chamber of the processing area of the present invention.

FIG. 7 is an elevational view of the processing facility of the present invention.

FIG. 8 is a plan view of the processing facility of the present invention illustrating the flow of waste from the processing area to a waste area.

FIG. 9 is a plan view of the processing facility illustrating differential pressure gradients and flow of air throughout the processing facility of the present invention.

### DETAILED DESCRIPTION

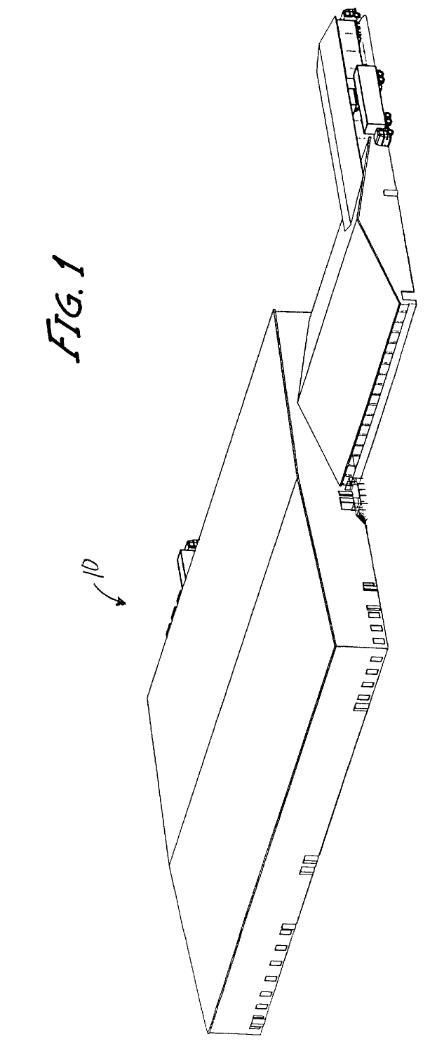

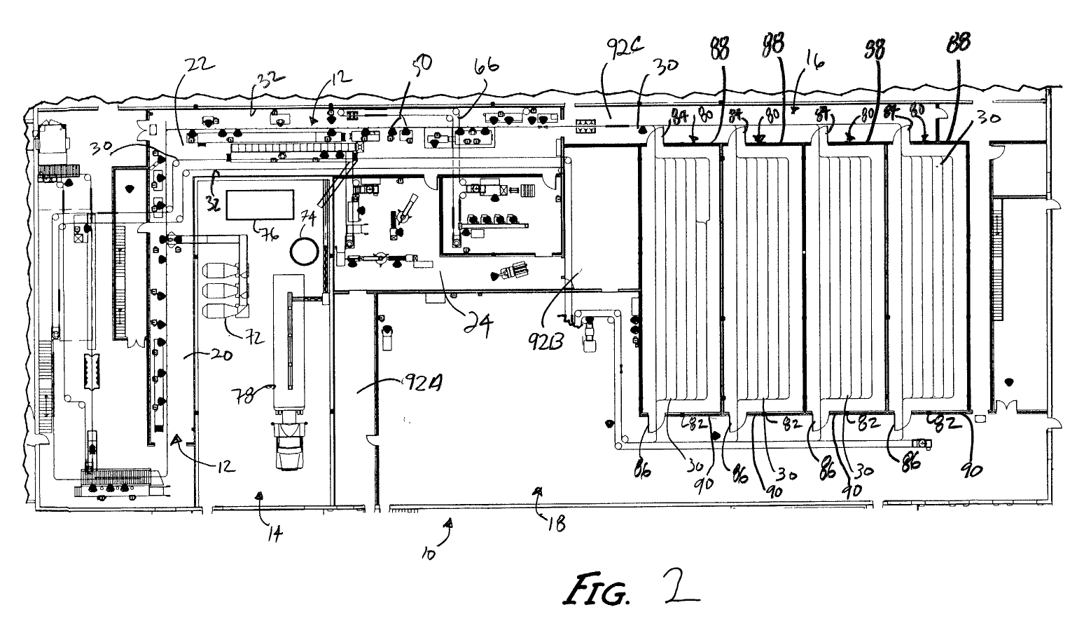

A livestock processing facility of the present invention is indicated generally at 10 in FIGS. 1 and 2. As illustrated in FIG. 2, the livestock processing facility 10 of the present invention generally comprises a processing area 12, a waste removal area 14, a storage area 16 and a packaging area 18. The processing facility 10 further comprises stock yards (not shown) and administrative offices (not shown). The processing facility 10 of the present invention is designed to handle approximately 1,000-4,000 head of hog per shift, or 300 head of hog per hour. The processing facility of the present invention is also designed to handle approximately 300-900 head of cattle per shift, or 100 head of cattle per hour. However, it is within the scope of the present invention to provide a processing facility 10 of greater or less capacity, depending upon the desired capacity of the facility, suggesting a change in the physical size and shape o the facility.

The processing area 12 comprises a bleeding portion 20, a slaughter chamber (or “kill floor”) 22 wherein carcass work-up takes place, and an offal room 24. The bleeding portion 20 and slaughter chamber 22 are “in-line” or sequential to one another. A detailed description of the slaughter chamber 22 as used in the present invention is included in U.S. Application No. (H565.12-02), incorporated herein by reference. Preferably, the bleeding section and the kill floor 22 are laid out to substantially form a “L”-shaped configuration, each leg positioned adjacent to and partially circumscribing the waste removal area. Livestock is brought into the bleeding area 20 from the stockyards, stunned and put to death. Animal carcases 26 are hung and cut such that blood from the carcasses 26 is allowed to drain. A hanging system 28 is connected to an overhead conveying system 30, or a “walking-beam” conveyer system as is known to those skilled in the art. This type of conveyer system 30 minimizes the number of moving parts, and does not require oil-based lubricants, which can contaminate food products. Preferably, the walking beam conveyer system 30 is used along the entire length of the bleeding portion 20 and the kill floor 22 (i.e. both legs of the “L”-shaped configuration), transporting carcasses 26 from the bleeding portion 20 into the slaughter chamber 22.

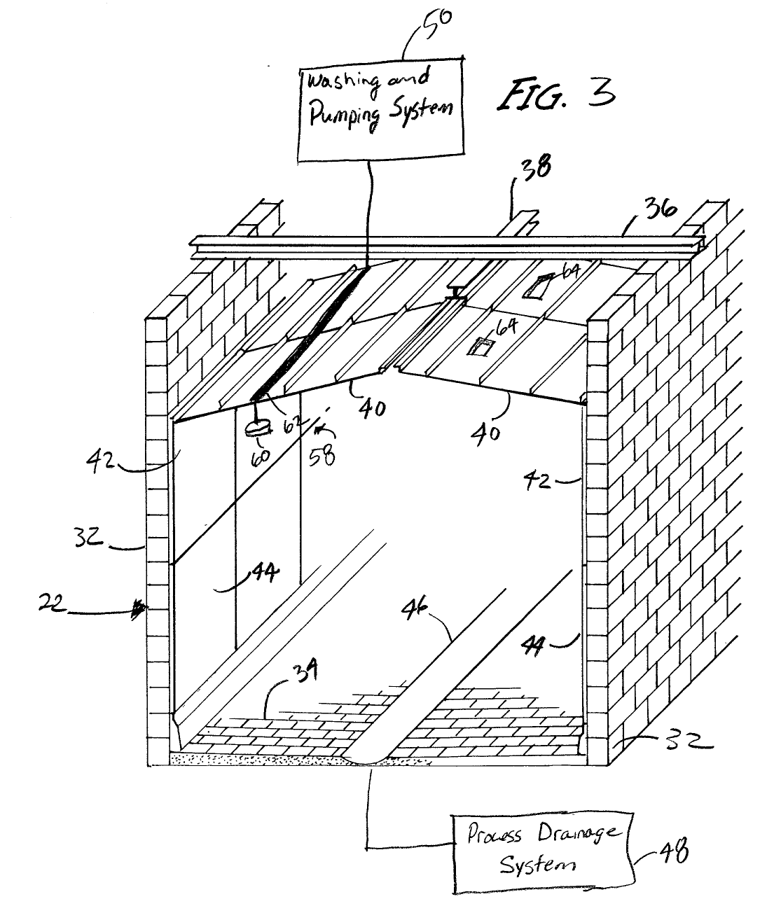

Referring to FIG. 3, the slaughter chamber 22 comprises supporting sidewalls 32 which may be constructed of concrete, cinder blocks, bricks or other similar masonry, and a floor 34 preferably constructed of split-pavers as is well known in the art. It should be noted, however, that alternative constructions of the floor 34, including cement, gratings or the like, are within the scope of the present invention. The sidewalls 32 support a plurality of cross-beams 36 which in turn support a center support beam 38. Stainless steel panels 40 are attached to the center support beam 38 to form a stainless steel ceiling. The sidewalls 32 preferably comprise top panels 42 and bottom panels 44. The top panels 42 are joined to the ceiling panels 40 and the bottom panels 44 are joined to the floor 34 to make the slaughter chamber 22 water impermeable. Dimensions of the slaughter chamber 22 will vary depending on the livestock being processed. Preferably, the floor 34 is provided with a continuous gutter drain 46, with strategically located drain points. These drains are connected to a process drainage system 48. The drain system 48 of the slaughter chamber 22 may be designed to match any general guideline directed by the United States Department of Agriculture, the Food Safety Inspection Service or any other regulating body for food safety. The floor 34 has the same grade throughout, having a sloped center gutter 46 connected to the drainage system 48.

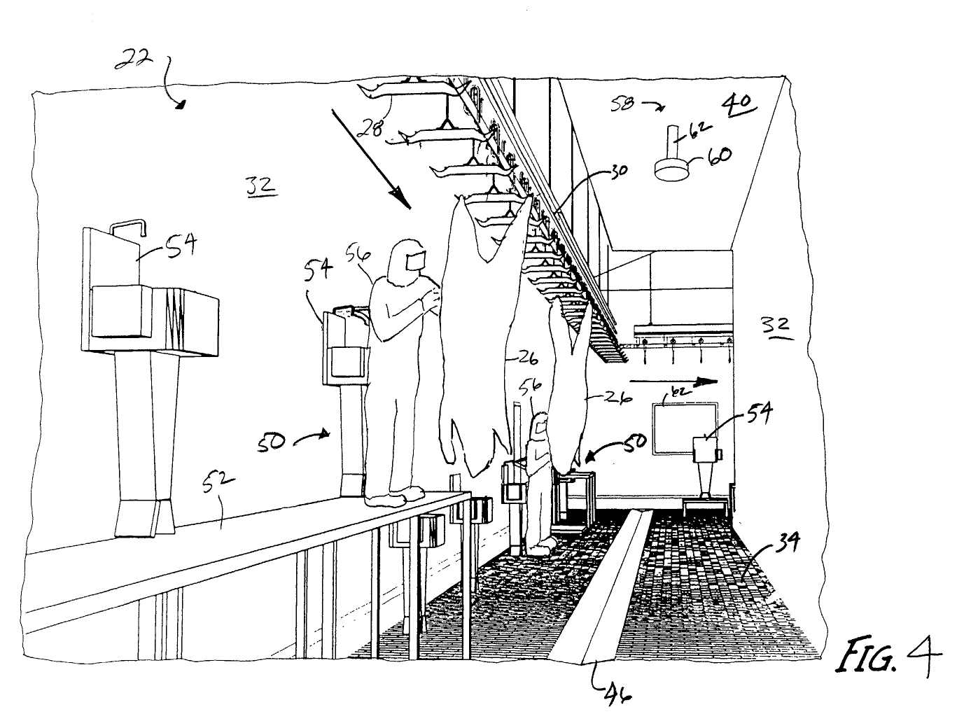

Referring to FIG. 4, the slaughter chamber 22 further includes a plurality of work stations 50 at which workers perform a variety of tasks when disemboweling or eviscerating each carcass 26. These stations 50 are located at various positions and heights throughout the slaughter chamber 22. The work stations 50 are either located on the floor 34 or on a raised platform 52, and are also constructed of stainless steel. Sinks 54 constructed of either stainless steel or plastic indicate the general area where a worker stands to perform a selected task upon the carcass 26. FIG. 4 includes a depiction of two carcasses 26 hanging from the hanging system 28 on the overhead conveyer 30, and workers 56 performing different tasks upon on the carcass 26 at each station 50. Such tasks include, but are not limited to, leaf pulling, eviscerating, and splitting. The inspections include the head inspector, viscera and rail inspection. In operation, the carcass 26 is transported by the overhead conveyer system 30 past a worker 56. The worker stops the carcass 26, performs a selected task upon the carcass 26, and then the carcass 26 passes to the next station 50. The worker need not travel with the carcass 26 because of the design of the “walking-beam” overhead conveyer system 30.

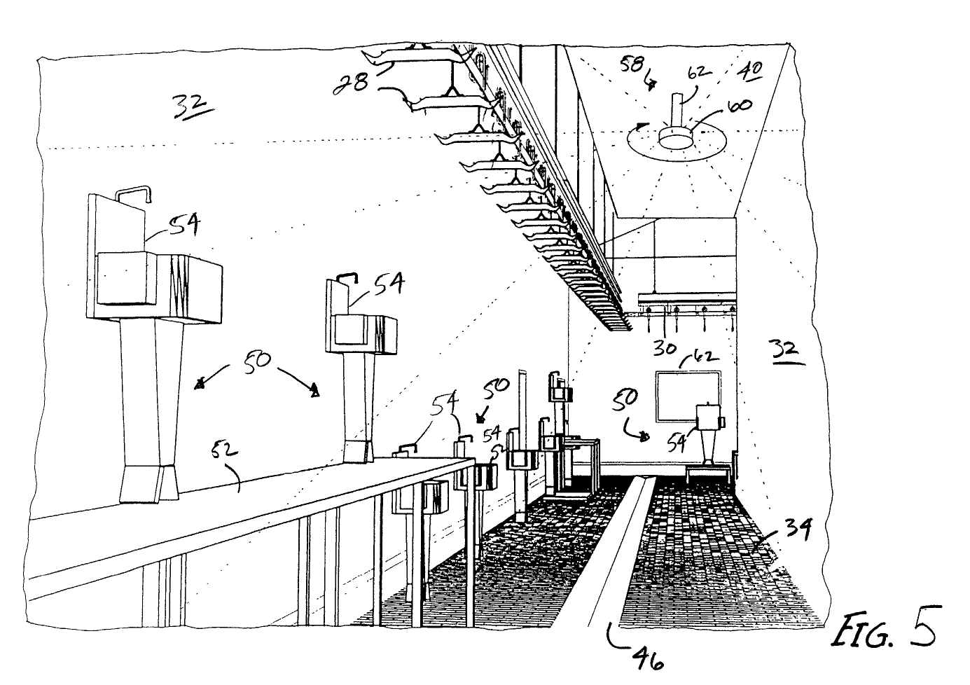

The slaughter chamber 22 further comprises an automated washing system 58 for removing waste products at regular intervals from the slaughter chamber 22, thus improving sanitary conditions of the processing facility 10. The automated washing system 58 preferably comprises a plurality of nozzles 60 attached to a water conduit 62 running outside the slaughter chamber 22. Preferably each nozzle 60 may rotate, emitting a pressurized jet of water in various directions to clean the inside of the slaughter chamber, as best illustrated in FIG. 5. Upon pumping water through the conduit 62, each nozzle 60 spews out a jet of water in various directions, increasing the effectiveness and thoroughness of the washing system 58. Water pressure supplied to each nozzle 60 is preferably within the range of 1200 to 1500 pounds per square inch when directing a pressurized fluid or cleaning. The water pressure can be as low as 5 pounds per square inch when emitting a foaming cleanser to soak within the chamber 22. The spray nozzles 60 are strategically located to provide the most efficient wash-down process, utilizing large and small nozzles. Alternatively, it would be within the scope of the present invention to position a plurality of stationary nozzles 60 within the slaughter chamber, each nozzle 60 directed at a specific point, such as a ceiling panel 40, the floor 34 or wall panel 42 or 44, or at a specific work station 50.

The slaughter chamber 22 is a self-contained chamber, with the stainless steel construction of the ceiling panels 40 and sidewall panels 42 and 44 preventing contamination of waste products and water into other areas of the livestock processing facility 10. Apertures 64 are located throughout the slaughter chamber 22 to position light fixtures, utility outlets and spray nozzles 60 at strategic locations.

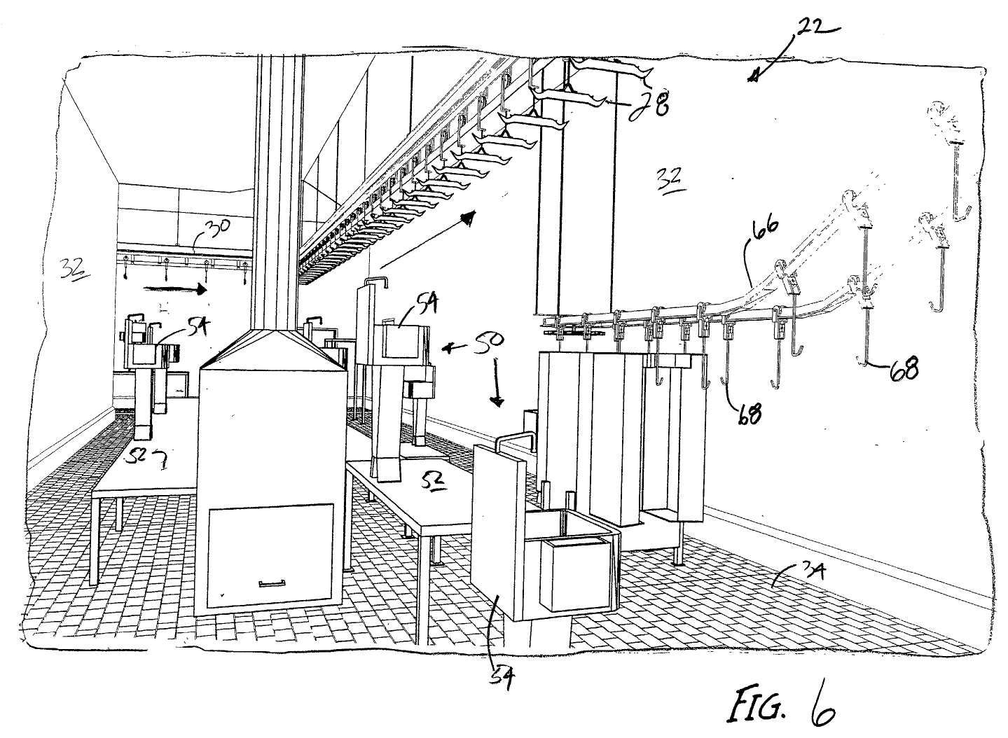

The slaughter chamber 22 further comprises a second overhead conveyer system 66, as best illustrated in FIG. 6. The second conveyor system 66 comprises a series of hooks 68 for attaching certain body parts harvested from each carcass 26. The hooks 68 carry the harvested body part, by way of the second overhead conveyer system 66, to the offal room 24 or packagers area 18 of the facility 10 where the harvested part can be further processed or packaged for shipment.

For sanitation reasons, the slaughter chamber 22 should be periodically washed to remove bodily material and fluids generated by disemboweling the carcasses 26. These bodily materials and fluids can contaminate other carcasses 26 traveling through the carcass work-up portion 22 by either direct contact or by airborne micro-organisms. With the present invention, the cleaning of the slaughter chamber 22 can be accomplished quickly and effectively.

To operate the automatic, self-cleaning system 58, introduction of additional carcasses 26 into the slaughter chamber 22 is momentarily stopped, and the remaining carcasses 26 already within the slaughter chamber 22 are processed past each of the stations 50. Each worker then exits the slaughter chamber area 22. A four cycle cleaning system is then initiated. Pumps (not shown) connected to the conduits 62 located outside the slaughter chamber 22 are activated. During the first cycle, pumps supply the nozzles 60 with water to flush the ceiling panels 40, sidewall panels 42 and 44 the floor 34 and the work stations 50 of the slaughter chamber 22. Upon flushing, the second cycle begins wherein a cleaning agent is pumped through the nozzles 60 and directed onto the same items as did the previous cycle to flush the slaughter chamber 22. Upon washing, the third cycle is initiated wherein water is once again pumped through the system to rinse the ceiling 40, floor 34, sidewalls 42 and 44 and work stations 50 of the slaughter chamber 22. Preferably, the first and third cycles use a substantially aqueous solution to flush and rinse the slaughter chamber 22. However, it is well within the scope of the present invention to use other solutions, which include, but are not limited to, sanitation solutions, anti-bacterial solutions, chlorinated solutions such as bleach, bromine solutions, and the like. Additionally, the term cleaning agent as used herein means any type of solution, including an aqueous solution, that will aid in the removal of surface debris including, but not limited to, detergents, soap, bleach, and the like. Finally, the fourth part of the cycle includes dry air being pumped through the slaughter chamber 22 to remove excess water. The air may be heated to increase its water retaining capacity. Upon completion of the fourth cycle, the slaughter chamber 22 is ready for workers to re-enter and resume processing carcasses.

The self-containment of the slaughter chamber 22 ensures that all the of water, bodily matter and fluids exit the slaughter chamber 22 during wash down through the drainage system 48, thus preventing any other areas of the processing facility 10 from being contaminated with the aforementioned waste products. These waste products, which include the contaminants along with the washdown water emitting from the nozzles 60, wash and flow into the drainage system 48. From there, the waste products gravitationally flow toward the waste removal area 14. Preferably, the cleaning cycle is repeated at a regular interval of four hours, and should last between 10-15 minutes, which can easily be correlated to correspond with the workers' break time. Thus, when all of the workers leave for a lunch or coffee break, the slaughter chamber can be cleaned and sanitized in about 10-15 minutes, and be ready for processing of additional carcasses when the workers come back from break.

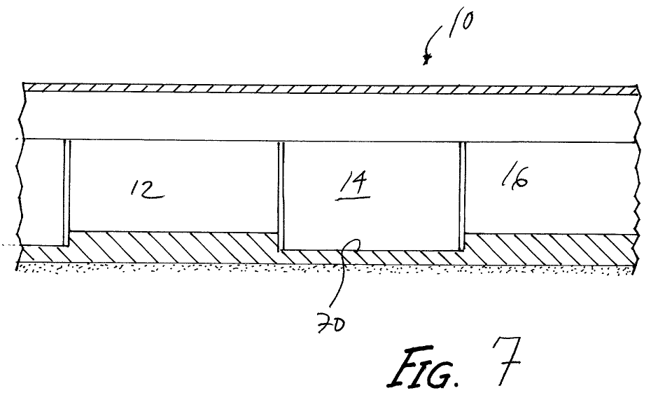

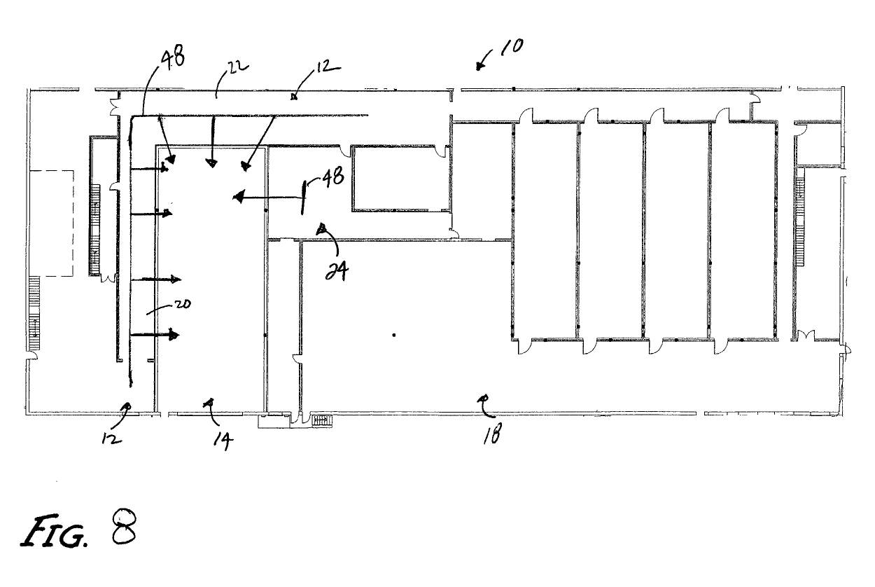

The waste removal section 14, also known as the “condemned room”, a term familiar to those skilled in the art, generally comprises a large rectangular room positioned within the facility 10 separated from the storage area 16 and the packaging area 18, as best illustrated in FIG. 2. The condemned room 14 generally comprises a floor 70 having a height lower than other operating floors of the processing and storage areas, as best illustrated FIG. 7. The lower height of the floor 70 in the condemned room 14 assists in the gravitational flow of waste products from the processing area 12, as previously described. FIG. 8 illustrates the general flow of waste from the processing area 12 to the condemned room 14. The condemned room further comprises collection tanks 72, basins 74 and bins 76 used for collecting the waste products. Preferably, solid waste products are separated and set aside for proper disposal, with the liquid waste products collected for further processing. The condemned room 14 is designed such that trucks and trailers 78 can be driven directly into the condemned room 14 to load waste products, both solid and liquid, for transportation to desired destinations (e.g. water treatment facilities, rendering facilities and land fills). Upon the trucks 78 entering and leaving the condemned room 14, air pressure is momentarily increased throughout the condemned room, so it is preferable to limit the number of times per day that trucks are allowed to enter and exit. This occurs about a maximum of four times per day, and only a few minutes at each time.

The storage area 16 of the present invention comprises a plurality of modular coolers 80, as best illustrated in FIG. 2. Each modular cooler 80 is positioned in longitudinal parallel relation to the others. Each modular cooler 80 includes an entrance door 84 and an exit door 86 located on opposing end walls 88 and 90, respectively. Each cooler 80 is integrated with the conveying system 30 to move carcasses about. Fully dressed carcasses 26 hung on hanging system 28 are brought through an adjoining corridor 92C and in through the entrance door 84 nearest the corridor 92C. The carcasses 26 are positioned within the modular cooler 80, and allowed to cool. When needed for further processing, the cooled carcasses 26 are brought through the second exiting door 86, which is near the packaging area 18.

The modular coolers 80 are designed such that only one door 84 or 86 need be opened when either bringing the carcasses 26 into the modular cooler 80, or when bringing the carcasses 26 out of the cooler 80. This improves quality control of the meat in that air, which may contain micro-organisms or other contaminants, is not free to travel from the carcass work-up area 22 to the packaging area 18. Furthermore, the temperature in each cooler 80 is easier to control when a draft is not allowed to flow through the cooler 80 when either filling or emptying the cooler 80.

The design of the modular coolers 80 also improves the sanitary conditions of the cooling system. Any one cooler 80 can be shut down for repairs, and more importantly for cleaning, without shutting down the entire cooling system. Each cooler 80 is operated by separate refrigeration systems, including separate compressor units 82 such that if one unit 82 were to malfunction, only the malfunctioning cooler 80 would have to shut down, not the entire storage area 16, allowing the processing of carcasses 26 to continue. This ensures that meat in functioning coolers 80 remain at a selected cooling temperature. Also, more sanitary conditions can be practiced since the modular coolers 80 can be cleaned more frequently.

Preferably, there are four modular coolers 80 employed in the present invention. The quantity of carcasses 26 each modular cooler 80 is designed to hold is enough that it should take approximately two hours to fill under normal operating conditions. Thus four modular coolers 80 can hold a full eight-hour shift. Preferably, at any given time during normal operation conditions, as processed carcasses 26 are brought into one cooler 80, chilled carcasses are brought out of a second cooler 80, a third cooler 80 should be filled to capacity, and the final cooler 80 should be empty and cleaned. Thus, after each cooler 80 is emptied to further process the carcasses 26 in packaging area 18, the emptied cooler 80 can be cleaned without disrupting the operation of the facility 10, since using modular coolers 80 allows a three step process of “fill”, “empty” and “clean” to occur (i.e. as one cooler 80 is being cleaned, another is being filled, a third cooler 80 is being emptied, and a fourth cooler 80 is full).

The layout and design of the processing areas 12, waste removal section 14, storage area 16 and packaging area 18 of the present invention is essential for controlling air flow within the facility 10. Referring back to FIG. 2, the waste area 14 is positioned approximately mid-way within the processing facility 10. The bleeding portion 20 and the carcass work-up portion 22 are situated to comprise an approximate “L”-shaped configuration, peripherally wrapping partially around the waste area 14. The offal room 24, where marketable products such as the organs of the animal are collected, is positioned adjacent to both the slaughter chamber 22 and the waste area 14. Positioning the condemned room 14 between the areas where slaughtering occurs and areas where cooling and packaging occur provides a simple and effective method of controlling air flow. The condemned room 14 acts as a barrier between the processing area 12 and the storage and packaging areas 16 and 18 of the processing facility 10. By utilizing a “wrap around” processing area layout, an additional advantage of eliminating the need for various augers or conveyers to move products is gained. In particular, waste products can be gravity fed directly from the processing area 12 into the condemned room 14. Preferably, waste from either the bleeding portion 20, the carcass workup portion 22 or the offal room 24 is fed directly to the waste area 14 without having to pass through any other area of the facility (e.g., waste from the carcass work-up portion 22 travels directly to the waste area 14 without passing through either the bleeding portion 20, the offal room 24, the storage area 16 or the packaging area 18).

The facility 10 further includes strategically positioned corridors 92 which act as air locks between the “dirty side” of the processing facility where animals are brought in and slaughtered, and the “clean side” of the processing facility where edible meat products are cooled and prepared for packaging. A first corridor 92A is located between the condemned room 14 and the packaging area 18, and also borders a portion of the offal room 24. A second corridor 92B is located between a modular cooler 80 and the offal room 24, and also between the processing area 12 and the packaging area 18. The third corridor 92C comprises part of the storage area 16, and is positioned along the modular coolers 80 proximate the first opening 84 of each cooler. The third corridor 92C also shares a border with the second corridor 92B and an end portion of the processing area 12.

The layout and design of the processing facility 10 of the present invention allows for a more effective way to control positive air pressures and air flow throughout the entire processing facility. Each area 12-18, including the corridors 92, are designed to maintain a selectively adjustable air pressure. Generally, each area of the plant 10, including the processing area 12, the waste area 14, the storage area 16 and the packaging area 18 will be maintained at a differential pressure to control the overall airflow within the plant 10. Preferably, the packaging area 18 has the highest air pressure, with air pressures decreasing from the packaging section 18, to the storage area 16, to the processing area 12, to the waste area 14. It is advantageous to contain each of these areas separate from one another, and the layout of the processing facility 10 of the present invention ensures that proper containment is accomplished.

In the preferred embodiment of the present invention, the only portion of the processing facility 10 maintaining an atmospheric pressure are the stockyards, as they are typically open to the atmosphere. For the purpose of this disclosure, by one atmosphere it is meant approximately 14.7 pounds per square inch (or 408 inches of water). From the stockyards, each of the areas of the facility are maintained at an air pressure above or below atmospheric pressure.

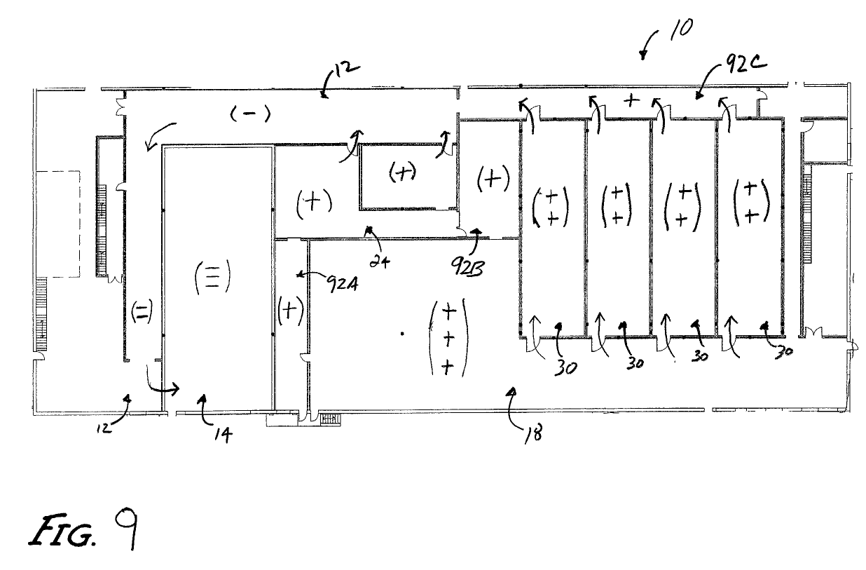

For example, the air pressure of the packaging area 18 is maintained at two units above atmospheric pressure, wherein a unit ranges from about a tenth of an inch of water to about an inch of water. However, preferably a pound per square inch. The air pressure of the storage area 16 is preferably maintained at one unit above atmospheric pressure. The air pressure of the processing area 12 is maintained between one and two units below atmospheric pressure, wherein the carcass work-up area 22 is maintained at one unit below atmosphere, and the bleeding portion 20 is maintained at two units below atmosphere. The lowest air pressure in the facility is that of the condemned room 14 which is maintained at about three units below atmospheric pressure. This differential pressure gradient of the processing facility 10, which is greatest in the packaging section 18 and least in the waste area 14, directs airflow within the plant to continuously flow towards the condemned room 14 and away from the packaging area 18. FIG. 9 illustrates the differential pressures and air flow within the facility. Each positive sign (+) indicates a unit above atmosphere, and each negative sign (−) indicates a unit below atmosphere.

Additionally, because each corridor 92 acts as a barrier between separate areas of the facility, the air pressure of each corridor 92 is also adjusted to maintain a pressure gradient between adjoining proximate areas. Preferably, the air pressure of the first corridor 92A is less than two units above atmosphere but greater than one unit below atmosphere, while the air pressure of the second corridor 92B is less than two units above atmosphere but greater than one unit below atmosphere, and the air pressure of the third corridor 92C is less than one unit above atmosphere but greater than one unit below atmosphere.

Preferably, air pressures for each area, portion or air lock are differentiated by separate air handling systems (not shown) known to those skilled in the heating, ventilating and air conditioning (HVAC) art. Outside air is either pumped into the areas having positive atmospheric pressure, or air is pumped out of areas having negative atmospheric pressures.

Finally, the layout of the processing facility 10 minimizes the time between killing and disembowelment of the animal, or using a phrase well known in the art, the time from ‘stick-to-gut.’ With processing facilities currently used in the art, ‘stick-to-gut’ times of 16-20 minutes are typical. Utilizing the process facility layout of the present invention, ‘stick-to-gut’ times as low as nine minutes are well within the scope of the present invention. Minimizing ‘stick-to-gut’ time is advantageous for several reasons, including improving taste qualities of the meat, and reducing overall time to cool the carcass to better hinder biological break down of the meat (by maintaining certain pH levels within the meat).

Although the present invention has been described with reference to preferred embodiments, workers skilled in the art will recognize that changes may be made in form and detail without departing from the spirit and scope of the invention.

1. A slaughtering facility for processing animal carcasses, the slaughtering facility comprising:
a waste area;
a processing area, the processing area comprising at least two sequential processing portions wherein a selected task is performed on the carcass while passing through each processing portion, the processing area positioned adjacent to the waste area;
wherein waste from any processing portion of the processing area is directed to the waste area without passing through any other processing portion of the processing area.

2. The slaughtering facility of claim 1 wherein the processing area is substantially “L”-shaped and positioned along two adjoining sides of the waste area, the waste area having a substantially rectangular shape.

3. The slaughtering facility of claim 1 wherein the waste area includes a floor, the floor having a lower elevation than either a floor of the processing area or a floor of the storage area.

4. The slaughtering facility of claim 1 and further comprising a cooling system, wherein the cooling system comprises a plurality of coolers positioned in parallel relation to one another, each cooler comprising:
a first opening for entering processed carcasses;
a second opening for removing chilled carcasses;
a hanging system for transporting the carcasses; and
wherein the temperature of each modular cooler is selectively regulated.

5. The slaughtering facility of claim 1 wherein the processing portions of the processing area comprise:
a bleeding portion; and
a carcass work-up portion.

6. The slaughtering facility of claim 5 wherein the carcass work-up portion includes an automatic cleaning system to wash debris from the carcass work-up portion to the waste area.

7. The slaughtering facility of claim 5 wherein the carcass work-up portion includes a plurality of work stations, each work station selectively positioned to perform a selected task upon the carcasses.

8. The slaughtering facility of claim 1 and further comprising a storage area, the storage area separated from the waste area, wherein an air pressure of each area is selectively adjusted to control the flow of air, wherein the air pressure of the storage area is controlled to be greater than the waste area.

9. The slaughtering facility of claim 8 wherein the air pressure of the processing area is controlled to be greater than the air pressure of the waste area.

10. The slaughtering facility of claim 8 and further comprising a packaging area, wherein the air pressure of the packaging area is controlled to be greater than the air pressure of the storage area.

11. A slaughtering facility effective for controlling air flow within selected areas of the facility, the slaughtering facility comprising:
a processing area for bleeding livestock and working carcasses;
a waste chamber for the collection of waste, the waste chamber positioned central to the processing area;
a storage area for storing processed carcasses; and
wherein an air pressure of each area is selectively adjusted to maintain a differential pressure gradient greatest at the storage area and least at the waste chamber.

12. The slaughtering facility of claim 11 and further comprising an air lock positioned between the waste chamber and the storage area, the air lock preventing air flow from the waste area to the storage area.

13. The slaughtering facility of claim 12 wherein the waste chamber and the air lock each include a maintained air pressure, wherein the air pressure of the air lock is controlled to be greater than the air pressure of the waste compartment.

14. The slaughtering facility of claim 11 wherein the processing area is peripherally positioned at least partially about the waste chamber.

15. The slaughtering facility of claim 11 wherein a floor of the waste compartment is lower than a floor of the processing area or a floor of the storage area.

16. The slaughtering facility of claim 11 wherein the processing area includes a bleeding portion, an carcass work-up portion and an offal portion, each portion positioned adjacent to the waste chamber.

17. A slaughtering facility for processing livestock, the slaughtering facility controlling the flow of air from one area in the facility to another area in the facility, the slaughtering facility comprising:
a waste area for collection and disposal of waste;
a processing area for bleeding and working carcasses;
a storage area for cooling processed carcasses;
wherein the processing area at least partially circumscribes the waste area; and
wherein an air pressure of the storage area is greater than an air pressure of either the processing area or the waste area.

18. The slaughtering facility of claim 17 and further comprising an air lock separating the storage area from the processing area and the waste area.

19. The slaughtering facility of claim 18 wherein the air pressure of the air lock is greater than the air pressure of the either the processing area or the waste area.

20. The slaughtering facility of claim 18 wherein the air pressure of the air lock is less than the air pressure of the storage area.

21. The slaughtering facility of claim 17 wherein the processing area comprises:
a bleeding portion for stunning and bleeding the livestock;
an carcass work-up portion for eviscerating, dressing and cleaning the carcasses; and
wherein the bleeding portion and the carcass work-up portion have a higher controlled air pressure than the waste area.

22. The slaughtering facility of claim 21 wherein the carcass work-up portion has an air pressure controlled to be higher than an air pressure of the bleeding portion to direct the flow of air within the processing area from the carcass work-up portion to the bleeding portion.

23. The slaughtering facility of claim 21 wherein the carcass work-up portion has an air pressure controlled higher than an air pressure of the bleeding portion to prevent the flow of air from the bleeding portion to the carcass work-up portion.

24. The slaughtering facility of claim 21 wherein waste from the carcass work-up portion is directed through a conduit to the waste area without passing through the bleeding portion.

25. The slaughtering facility of claim 21 wherein waste from the bleeding portion is directed through a conduit to the waste area without passing through the carcass work-up portion.

26. The slaughtering facility of claim 21 wherein the processing area further comprises an offal portion for collecting and processing offal, the offal portion positioned adjacent the waste area and having a higher air pressure than the waste area.

27. The slaughtering facility of claim 26 wherein waste from either the bleeding portion, the carcass work-up portion, or the offal portion is directed through a conduit to the waste area without traveling through any other portion of the processing area.

28. The slaughtering facility of claim 17 wherein the carcass work-up portion comprises:
a self-contained chamber comprising:
sidewalls;
a ceiling; and
a floor;
a plurality of nozzles effective for directing pressurized fluid onto the sidewalls, the ceiling or the floor of the chamber;
a drainage system operatively connecting the chamber to the waste area; and
wherein activating the nozzles, the chamber is automatically cleaned of carcass work-up debris, the carcass work-up debris being flushed through the drainage system to the waste area.

29. The slaughtering facility of claim 28 wherein the self-contained chamber is constructed of stainless steel.

30. The slaughtering facility of claim 28 and further comprising work stations selectively positioned within the chamber for performing tasks upon each carcass, the nozzles also effective for directing pressurized fluids onto the work stations to remove carcass work-up debris upon activation.

31. The slaughtering facility of claim 28 wherein the pressurized fluid includes water, cleaning agents, or a mixture thereof.

32. The slaughtering facility of claim 28 wherein the fluid is pressurized from about 1200 to about 1500 pounds per square inch.

33. The slaughtering facility of claim 17 wherein the storage area comprises a plurality of modular coolers positioned in parallel relation to one another, each cooler comprising:
an entrance for the delivery of processed carcasses;
an exit for the removal of chilled carcasses;
a conveying system for moving the carcasses from the entrance to the exit; and
wherein the temperature of each cooler is selectively controlled independent of any other cooler.

34. The slaughtering facility of claim 33 wherein the entrance and the exit are positioned on opposite ends of each modular cooler.

35. The slaughtering facility of claim 33 wherein each modular cooler further comprises a separate cooling system to independently regulate the temperature of each cooler.

36. A method of slaughtering livestock within a slaughtering facility, the method controlling airflow and transportation of waste within the slaughtering facility, the method comprising the steps of:
positioning a central waste area within the facility;
positioning a processing area within the facility adjacent the central waste area, the processing area at least partially circumscribing the waste area;
positioning a storage area within the facility separated from waste area;
selectively controlling an air pressure of the central waste area, the processing area, and the storage area such that the air pressure of the storage area is greater than the air pressure of the processing area and the waste area.

37. The method of claim 36 and further comprising the step of directing waste from the processing area directly to the waste area.

38. The method of claim 36 wherein the air pressure of the processing area is controlled to be greater than the air pressure of the waste area.

39. The method of claim 36 and further comprising the steps of:
positioning an enclosed chamber within the processing area, the enclosed chamber comprising:
a floor;
sidewalls;
a ceiling wherein the floor, sidewalls and ceiling are joined together to be impermeable to water; and
a washing system to clean evisceration debris from the floor, the ceiling and the sidewalls;
eviscerating animals within the enclosed chamber;
directing workers to exit the enclosed chamber at regular intervals; and
activating the washing system, the washing system automatically cleaning evisceration debris from the floor, the ceiling and the sidewalls of the enclosed chamber.

40. The method of claim 39 wherein a regular interval occurs about every four hours.

41. A cooling system for use within a slaughtering facility, the cooling system including a plurality of modular coolers positioned in parallel relation to one another, each cooler comprising:
a first opening for delivery of processed carcasses;
a second opening positioned opposite the first opening for the removal of chilled carcasses;
a refrigeration unit to selectively adjust the temperature of the cooler; and
wherein the temperature of each cooler is selectively controlled independent of any other cooler.
